(19) United States
(12) Patent Application Publication
(10) Pub. No.: US 2023/0245062 A1
(43) Pub. Date: Aug. 3, 2023

(54) DEVICES, SYSTEMS, AND METHODS FOR BLOCKCHAIN-BASED INVENTORY MANAGEMENT

(71) Applicant: Pyxelchain Technology Corporation, Sheridan, WY (US)

(72) Inventor: Richard E. Silver, Fall Creek, OR (US)

(73) Assignee: Pyxelchain Technology Corporation, Sheridan, WY (US)

(21) Appl. No.: 18/160,865

(22) Filed: Jan. 27, 2023

Related U.S. Application Data
(60) Provisional application No. 63/304,929, filed on Jan. 31, 2022.

(51) Int. Cl. G06Q 10/087

(52) U.S. Cl. CPC G06Q 10/087; G06Q 2220/18

(57) ABSTRACT

A storage architecture and associated usage techniques are described for controlling and managing inventory via use of public blockchain tokens, such as to control manufacturing and/or transfer of physical goods based on issued inventory management control non-fungible tokens. In some situations, access to specified physical goods is restricted according to one or more defined inventory-related criteria (e.g., as part of instructions specified by the manufacturer or a distributor of those physical goods), and the restricted access is managed by automated operations to determine whether and when to provide access to such inventory and by establishing the new access (when so determined) via minting of one or more corresponding new inventory management control tokens (e.g., non-fungible tokens) on a publicly accessible blockchain storage to represent the new access, with such inventory management control tokens then used to control or otherwise manage corresponding manufacturing and/or distribution activities.

### CROSS-REFERENCE TO RELATED APPLICATIONS

The present application is related to U.S. Provisional Patent Application No. 63/304,929, titled BLOCKCHAIN-BASED INVENTORY MANAGEMENT filed Jan. 31, 2022, the disclosure of which is hereby incorporated by reference in its entirety.

### TECHNICAL FIELD

The following disclosure relates generally to using a blockchain storage architecture to manage inventory, such as to use blockchain non-fungible tokens to control manufacturing and/or distribution activities for physical goods.

### BACKGROUND

Managing inventory of physical goods is an important activity, but presents various difficulties, including in making decisions related to manufacturing and/or distribution activities in accordance with changing conditions, and including to track authenticated ownership of physical goods.

### BRIEF DESCRIPTION OF THE DRAWINGS

FIG. 1A is a network diagram illustrating an example environment in which an embodiment of a Token Inventory Management (TIM) system is provided and used for controlling manufacturing of physical goods based at least in part on inventory management control tokens stored on public blockchain storage, including illustrating example computing systems suitable for executing an embodiment of such a system.

FIG. 1B is a network diagram illustrating an example environment in which an embodiment of a TIM system is provided and used for managing distribution of inventory based at least in part on inventory management control tokens stored on public blockchain storage, including illustrating example computing systems suitable for executing an embodiment of such a system.

FIG. 2 illustrates a flow diagram of an example embodiment of a Token Inventory Management (TIM) System routine.

### DETAILED DESCRIPTION

A storage architecture and associated usage techniques are described for providing efficient and transparent management and control of inventory via use of public blockchain tokens, such as to control manufacturing of physical goods and/or transfer of physical goods based on issued inventory management control non-fungible tokens. In at least some embodiments, access to specified physical goods is restricted according to one or more defined inventory-related criteria (e.g., as part of manufacturing instructions specified by a manufacturer of those physical goods, or other inventory-related instructions specified by a manufacturer or distributor of those physical goods), and a Token Inventory Management (TIM) system manages the restricted access by determining whether and when to provide access to such inventory and by establishing the new access (when so determined) via minting of one or more corresponding new inventory management control tokens (e.g., non-fungible tokens) on a publicly accessible blockchain storage to represent the new access, with such inventory management control tokens then used to control or otherwise manage corresponding manufacturing and/or distribution activities. In such embodiments, information about the inventory management control tokens that is stored on the publicly accessible blockchain storage may be retrieved and inspected by the executing software programs (and/or users associated with the software programs) to provide transparent information about the providing of the new access, such as to enable independent validation that inventory-related criteria are correctly applied. In addition, in at least some embodiments, the access control by the TIM system includes allocating an amount and/or type of ownership rights to a particular recipient (e.g., that may be redeemed by that recipient under specified circumstances). The described techniques are, in at least some embodiments, performed at least in part by automated operations of a computer-implemented Token Inventory Management (TIM) system, as discussed in greater detail below.

As noted above, publicly accessible blockchain storage (e.g., distributed blockchain storage) is used in at least some embodiments to store inventory management control tokens and optionally associated ownership rights data, such as by using a bitcoin-based blockchain storage and/or an Ethereum-based blockchain storage and/or a Flow-based blockchain storage and/or another type of blockchain storage. As noted above, in at least some embodiments, a TIM system may mint new blockchain tokens to represent new inventory access that is provided, and such inventory management control tokens may have various forms in various embodiments (e.g., an Ethereum ERC-721 non-fungible token; an Ethereum ERC-1155 non-fungible token; an Ethereum ERC-20 fungible token; a Flow non-fungible token; a bitcoin non-fungible or fungible token; a Cardano non-fungible or fungible token; a DOT non-fungible or fungible token; any non-fungible or fungible token implemented as a smart contract with specific instructions, such as a program, to be executed or otherwise implemented when specified conditions occur; etc.), including to incorporate various types of information, and to be implemented as smart contracts in at least some such embodiments.

In addition, various types of inventory-related criteria may be used by an embodiment of the TIM system to control access to various types of inventory in various embodiments, including to determine whether and when to mint new inventory management control tokens to establish access of a recipient to a new inventory item (e.g., a physical good to be manufactured and delivered or otherwise provided to the recipient, a physical good to be delivered or otherwise provided to the recipient from a distributor or other entity with physical control of the physical good, etc.).

As one non-exclusive example, a manufacturer of a type of physical goods may provide inventory management instructions to the TIM system that authorize the providing to one or more recipients of a specified amount of the physical goods (e.g., a maximum and/or minimum quantity; a maximum and/or minimum rate for one or more specified time periods; etc.), but with some or all of those physical goods not yet being manufactured or otherwise produced, and with those inventory management instructions further optionally including one or more inventory-related criteria—such inventory-related criteria may include, for example, one or more of the following: one or more conditions to be satisfied for an acquisition of one or more of the physical goods by a potential recipient, such as related to timing, recipient identity and/or characteristics, authorized uses, acquisition pricing and/or other acquisition terms, etc.; one or more conditions to be satisfied for a transfer of ownership rights after acquisition of one or more of the physical goods from a current recipient owner to a potential new recipient, such as related to timing (e.g., a minimum and/or maximum number of days of ownership before transfer), related to acquisition terms (e.g., a minimum and/or maximum increase and/or decrease in acquisition pricing and/or other minimum and/or maximum change in other acquisition terms, optionally including no change allowed in acquisition pricing and/or other acquisition terms), related to acquiring entities (e.g., a minimum and/or maximum number of possible entities to which the transfer opportunity is made available), related to transfer-related rights of the manufacturer (e.g., rights to receive notice of when a transfer opportunity is offered, such as to provide a right of first refusal; rights to receive notice of the completion of a transfer, such as to enable the manufacturer to maintain records of current ownership; rights to a specified portion of money or other compensation received by the current recipient owner as part of the transfer, such as a specified percentage or fixed amount; rights to reversion of ownership back to the manufacturer, or other indicated remedy, if specified conditions are not satisfied, such as to optionally provide a type of theft prevention mechanism in which the corresponding issued inventory management control tokens act as a type of unique ‘serial number’ to allow the verified recipient owner of a particular physical good to be verified; etc.), or to instead prohibit any such transfer of ownership rights after acquisition of one or more of the physical goods from a current recipient owner to a potential new recipient, etc.; one or more conditions to be satisfied for use of one or more of the physical goods after acquisition; etc.).

The TIM system may then manage the access of potential recipients to acquire that specified amount of the physical goods in accordance with any specified inventory-related criteria, including, when a recipient is determined by the TIM system to be authorized to receive one or more of the physical goods (e.g., in response to an acquisition request received by the TIM system from that recipient or from another entity on behalf of that recipient), for the TIM system to issue one or more new inventory management control tokens on one or more public blockchain systems corresponding to authorization of the acquisition, with corresponding manufacturing requests or instructions provided to the manufacturer (e.g., by the TIM system, by the recipient or other acquiring entity, etc.), with the manufacturer then proceeding to manufacture and deliver (or otherwise provide) the authorized one or more physical goods to the recipient in response to or otherwise in accordance with the existence of the issued inventory management control token(s). An issued inventory management control token may encode or otherwise store various information in various embodiments (e.g., metadata associated with the one or more physical goods and/or with their acquisition), including in some embodiments and situations for some or all such information to be included in a visible or otherwise perceptible representation generated for the token when it is displayed or otherwise presented, and with non-exclusive examples of such various information including one or more types of information as follows: information to identify the recipient; information to identify the type of physical good (e.g., for fungible goods); information to identify a specific copy of the physical good (e.g., for non-fungible goods, or goods that have associated unique serial numbers or other unique identifying attributes); information about delivery of the physical good(s) (e.g., a shipping or tracking number), and optionally to include update information (e.g., by updating the visible or otherwise perceptible representation of the token when displayed or otherwise generated, by generating a new associated token with the updated information, etc.); information about provenance of the physical good(s), such as a certificate of authenticity; information about the ownership rights (or other possession/control rights) represented by the token; information about authorized uses; information about warranties for the physical good(s) and/or other associated terms regarding the acquisition and/or use; etc.—as will be appreciated, the storage of such metadata on a blockchain system provides greatly security of the information relative to other off-blockchain storage, including due to the ability to review and verify the accuracy of the stored information. While discussed above with respect to a manufacturer, the same or similar inventory management instructions may be provided to the TIM system by a distributor that stores or otherwise has access to one or more of the physical goods (whether instead of inventory management instructions from the manufacturer and/or in addition to inventory management instructions from the manufacturer), and/or by another provider of goods (e.g., a wholesaler, retailer, etc.), with the TIM system similarly controlling access to distribution of those physical goods from the distributor (or other provider) to one or more recipients and generating the same or similar types of inventory management control tokens, and the distributor (or other provider) delivering (or otherwise providing) the authorized one or more physical goods to the recipient based on the existence of the issued inventory management control token(s). Similarly, the same or similar inventory management instructions may be provided to the TIM system with respect to digital items (e.g., virtual items, electronic items, intangible items, non-fungible tokens, etc.) by corresponding entities such as those digital items' manufacturers, distributors or other providers, with the TIM system similarly generating the same or similar types of inventory management control tokens, and controlling access to distribution of those digital items to one or more recipients from their provider (e.g., manufacturer, distributor, etc.) and/or from the TIM system.

Similarly, if a recipient of one or more of the physical goods subsequently wants to transfer ownership of at least one of the physical goods to a new potential recipient, the TIM system may further manage such a potential transfer in accordance with any specified inventory-related criteria, including, when a potential new recipient is determined by the TIM system to be authorized to receive one or more of the physical goods currently owned by an existing recipient (e.g., in response to a transfer request received by the TIM system from the existing recipient or from the potential new recipient or from another entity), for the TIM system to issue one or more new inventory management control tokens on one or more public blockchain systems corresponding to the transfer (e.g., an authenticity inventory management control token that confirms that the physical good copy being transferred is authentic and/or valid, a new inventory management control token corresponding to ownership by the new recipient, etc.) and/or to transfer ownership to the new recipient of the existing one or more inventory management control tokens associated with the one or more physical goods that are being transferred, and optionally with corresponding requests or instructions to effectuate the receipt by the new recipient of the physical good(s) being provided (e.g., by the TIM system) to one or more of the existing recipient, the new recipient or the manufacturer/distributor (e.g., for the existing recipient to deliver or otherwise provide the existing physical good(s) to the new recipient; for the new recipient to retrieve or otherwise obtain the existing physical good(s) from the existing recipient; for the manufacturer to manufacture and deliver or otherwise provide a new copy of the physical good to the new recipient, optionally after the previous recipient's copy is verified to be returned or destroyed or otherwise disabled; for the distributor to deliver or otherwise provide a new copy of the physical good to the new recipient, optionally after the previous recipient's copy is verified to be returned or destroyed or otherwise disabled; etc.), and with the providing of the one or more physical goods to the new recipient then taking place (e.g., based on the existence of the issued inventory management control token(s) and on resulting actions of one or more of the TIM system, the existing recipient, the new recipient, and/or the manufacturer). In situations in which an authenticity inventory management control token is issued that confirms that a physical good copy being transferred is authentic and/or valid, the TIM system may further in some such embodiments allow subsequent transfer of ownership of the physical good copy to occur without further interactions of the TIM system (e.g., if there are not other inventory-related criteria to be enforced by the TIM system), such as directly between the existing recipient and the new recipient, optionally with the existing recipient (prior recipient after the transfer takes place) having the authenticity inventory management control token, and the new recipient (current recipient after the transfer takes place) having ownership of the original issued inventory management control token once the transfer takes place.

As another non-exclusive example, a manufacturer of a type of physical goods may have completed manufacturing or be in the process of manufacturing a specified amount of the physical goods (e.g., a specified quantity; a specified rate for one or more specified time periods; etc.), and may provide inventory management instructions to the TIM system that authorize the providing of those physical goods to one or more recipients (e.g., at an acquisition rate corresponding to a specified manufacturing rate, or otherwise at a specified acquisition rate for one or more specified time periods), and with those inventory management instructions further optionally including one or more inventory-related criteria as described above. The TIM system may then similarly manage the access of potential recipients to acquire that specified amount of the physical goods in accordance with any specified inventory-related criteria, including, when a recipient is determined by the TIM system to be authorized to receive one or more of the physical goods (e.g., in response to an acquisition request received by the TIM system from that recipient or from another entity), for the TIM system to issue one or more new inventory management control tokens on one or more public blockchain systems, with corresponding requests or instructions provided to the manufacturer (e.g., by the TIM system, by the recipient or other acquiring entity, etc.), and the manufacturer then proceeds to deliver (or otherwise provide) the authorized one or more physical goods to the recipient based on the existence of the issued inventory management control token(s).

As noted above, in some embodiments and situations, the TIM system may control access to the acquisition and/or transfer of physical goods or other inventory. As part of doing so, the TIM system may obtain and store information about particular existing and potential recipients in corresponding ownership accounts (e.g., information about the recipients, about their owned inventory items, about payment sources of the recipients, etc.), and use such information as part of determining whether inventory-related criteria for an acquisition or transfer are satisfied in a particular situation—in some embodiments and situations, such access may be based at least in part on a potential recipient having a current balance of one or more redemption credits issued by the TIM system (e.g., that are used in part or in whole as part of an acquisition price of a particular inventory item), with such redemption credits being issued to recipients and/or replenished after use according to defined redemption credit criteria, and with one non-exclusive example of use of redemption credits being available in U.S. Provisional Patent Application No. 63/235,035, filed Aug. 19, 2021 and entitled “Blockchain-Based Resource Management”, which is incorporated herein by reference in its entirety. Such existing and potential recipients may be users of various types of client computing devices to interact with the TIM system (e.g., over one or more computer networks, such as to interact with one or more server computing systems that implement the TIM system)—such client devices may include, for example, desktop computers, laptop computers and tablet computers and other portable computers, smart phone computing devices, etc. In addition, in some embodiments the TIM system may be operated by an entity different from other entities acting as manufacturers and/or distributors and/or other providers and/or recipients (e.g., whether executing on the same computing system(s) with software programs of some or all such other entities and/or on different computing systems), while in other embodiments the TIM system may be operated by at least one such other entity and optionally be incorporated together with other software of that other entity as part of a single software system providing functionality of both the TIM system and that other entity.

The described techniques provide various benefits in various embodiments, including that information about the inventory management control tokens used by the TIM system is stored on the publicly accessible blockchain storage and may be retrieved, inspected and validated not only by manufacturers and/or distributors or other providers to control their corresponding inventory item manufacturing and providing activities, but also by potential recipients and/or actual recipients and/or other parties to provide transparent information about the providing of corresponding access to inventory, such as to ensure that the inventory-related criteria are correctly applied. As non-exclusive examples, the described techniques may, in at least some embodiments and situations, enable one or more of the following: a manufacturer to determine demand levels and/or pricing levels for a particular type of item before manufacturing the item; a manufacturer or distributor or other provider to manage inventory and/or validate ownership (e.g., to reduce theft by preventing or inhibiting an ability to use and/or sell or otherwise transfer a stolen item, to prevent scalping and/or unauthorized use, etc.); a manufacturer or distributor or other provider to enforce a chain-of-custody policy that prevents unauthorized acquisition and/or use of its items; anyone to track authenticated ownership of physical goods in a transparent manner that allows others to verify the authenticated ownership; etc. Such described techniques further provide benefits in allowing improved control over access to inventory and related information, including to significantly reduce the computing power used and/or time used to determine ownership rights in specified circumstances, and to provide greater control of such inventory management according to defined inventory-related criteria. Various other benefits are also provided by the described techniques, some of which are further described elsewhere herein.

For illustrative purposes, some embodiments are described below in which specific types of operations are performed, including with respect to particular types of inventory, types of inventory-related criteria, types of recipients, types of item acquisitions and transfers, types of stored data, etc. For example, while the described techniques may be used in some embodiments to control the manufacture and/or distribution and/or transfer of physical goods by the TIM system using inventory management control tokens, the described techniques may be used in other embodiments to control the manufacture and/or distribution and/or transfer of other types of inventory (e.g., virtual items, electronic items, intangible items, property rights, fractional shares of physical goods, fractional shares of non-physical items, etc.), and/or to control access to functionality associated with verified ownership of a specified inventory of access rights (e.g., for use as a voting system by managing an inventory of eligible votes, such as based on each entity that is eligible to vote having ownership of one or more specified ‘votes’ in accordance with issued inventory management inventory control tokens; for use in controlling any other type of access to rights or other functionality associated with one or more owned items whose ownership is verified by corresponding inventory management control tokens; etc.). In addition, while the acquisition and transfer of inventory items is discussed above with respect to ownership rights, other types of possession and control of inventory items may be used in other embodiments and managed by the TIM system using inventory management control tokens, with non-exclusive examples including rental, lease, licensing, borrowing, trading or other exchanging, as well as fractional shares of ownership and/or other types of possession and control. Furthermore, while public blockchain storage is used in some examples below to store inventory management control tokens, other types of storage (e.g., private blockchain storage; permissioned blockchain storage; non-blockchain storage, such as single-system storage or distributed storage or peer-to-peer storage or cloud storage; etc.) may be used in other embodiments to store the same or similar types of information (in the form of non-fungible tokens, or in other forms), whether in addition to or instead of public blockchain storage. These examples are provided for illustrative purposes and are simplified for the sake of brevity, and the inventive techniques may be used in a wide variety of other situations, including with other types of inventory and inventory-related criteria, other types of recipients, etc., some of which are discussed below—accordingly, it will be appreciated that the described techniques are not limited to use with the example embodiments discussed below.

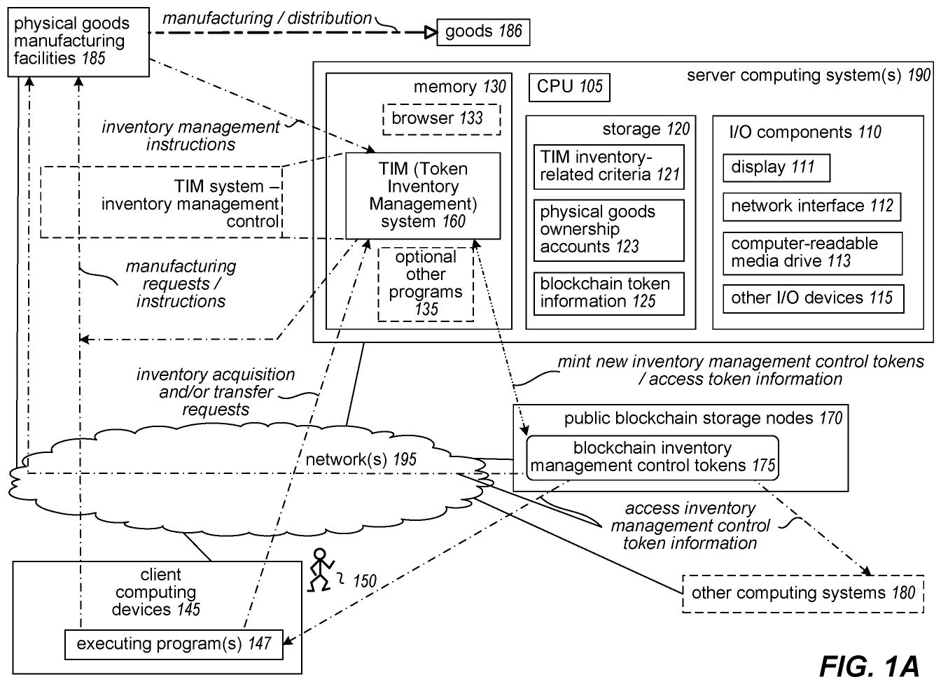

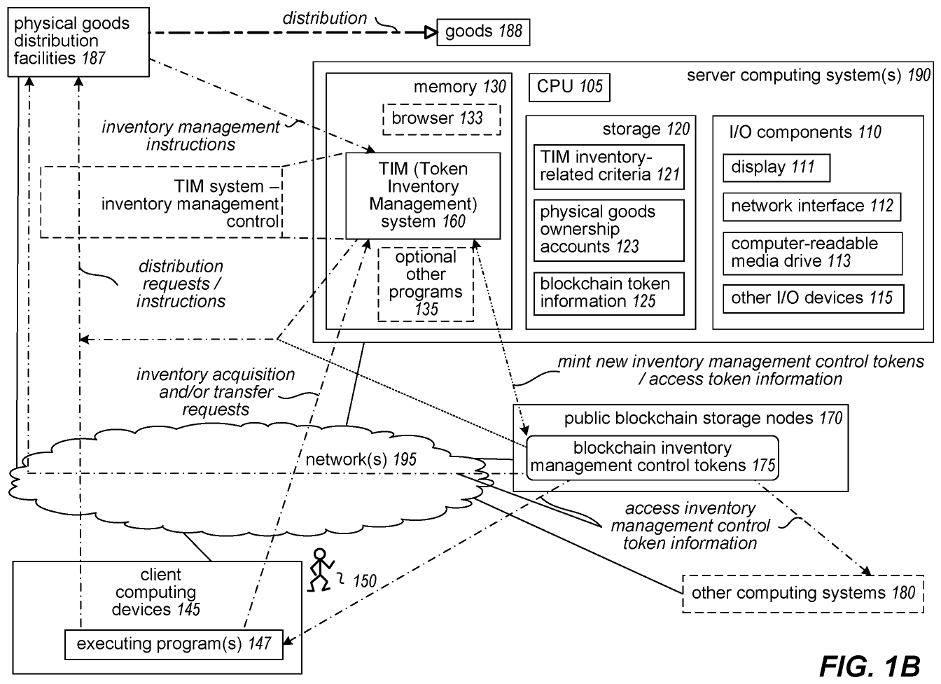

FIG. 1A illustrates an example environment in which an embodiment of a Token Inventory Management (TIM) system is provided and used for controlling manufacturing of physical goods and corresponding inventory management based at least in part on inventory management control tokens stored on blockchain storage. In particular, FIG. 1A illustrates one or more server computing systems 190 that execute an embodiment of a Token Inventory Management (TIM) system 160, which performs automated operations to control access to one or more types of physical goods 186 that are available to be manufactured by one or more manufacturers (not shown) using physical goods manufacturing facilities 185. In this example embodiment, the server computing systems 190 each includes various hardware components, as well as stored data and executable software instructions to program or otherwise configure the server computing system(s) and/or their hardware components to perform some or all of the described techniques—each of the other computing systems and/or devices and/or storage nodes (including computing and/or storage systems, not shown, at the manufacturing facilities 185) may similarly include some or all such hardware components (and optionally additional hardware components), but the details are not illustrated herein for the other computing systems for the sake of brevity. In particular, the example server computing system 190 includes one or more hardware central processing unit (“CPU”) processors 105, various hardware input/output (“I/O”) components 110, storage 120, and memory 130, with the I/O components in this example embodiment including a display 111, a network connection interface 112, a computer-readable media drive 113, and other I/O devices 115 (e.g., wireless or attached keyboards, mice or other pointing devices, microphones, speakers, cameras, other sensors, etc.). Other types of hardware components may additionally be present (e.g., other processors, such as a GPU, or graphics processing unit; a GPS, or global positioning system, transceiver and/or other location-determination sensors; one or more IMUs, or internal measurement units; etc.), but are not illustrated in this example.

In addition to the server computing systems 190, FIG. 1A further illustrates various client computing devices 145 that request and obtain access to the physical goods 186, multiple public blockchain storage nodes 170 on which inventory management control tokens are stored, one or more manufacturing facilities 185 with associated computing systems (not shown), and optionally other computing systems 180, with the various computing systems, devices, and storage nodes interacting in this example via one or more networks 195—some or all client computing devices 145 may each further have one or more associated users 150 for that respective client device, including in some situations and embodiments to direct or otherwise control actions of that respective client device. In addition, the network 195 may, for example, include portions of the Internet, a private network (e.g., a corporate network), a cellular network, or any other networks, including combinations of one or more such networks. The client computing devices 145 may also have various forms (e.g., a laptop, desktop, smart phone, tablet, etc.), and may each include various hardware components (e.g., in a manner similar to that of the server computing systems 190), such as to execute one or more programs 147 and optionally other programs (not shown), although such hardware components are not illustrated in this example. Similarly, the server computing systems 190 may optionally execute other programs in addition to the TIM system 160, such as an optional browser 133 and/or other optional programs 135. In addition, the various computing systems, devices and storage nodes may be connected to other systems and devices that are not illustrated, including through one or more networks such as the Internet or via the Web.

During its operation, the TIM system 160 may store and use various information on storage 120 and/or elsewhere, such as in one or more databases or other storage structures, including information 121 about inventory-related criteria and associated inventory management instructions and optionally other criteria used by the TIM system related to inventory management, information 123 about ownership accounts 123 associated with various users (e.g., the client computing devices 145 and/or their executing programs or users, such as current and/or past ownership of one or more items acquired via interactions with the TIM system, one or more amounts of resource access replenishment credits associated with a particular account of a particular user, etc.), and information 125 about blockchain tokens minted and used by the TIM system.

In the illustrated example embodiment, a manufacturer of physical goods that operates one or more facilities 185 may provide Inventory Management Instructions to the TIM system 160 for use by the TIM system in managing inventory of corresponding physical goods to be manufactured by the manufacturer, with associated data stored in the information 121. Subsequently, when a user corresponding to a client computing device sends an inventory acquisition request to the TIM system, the TIM system may use such information 121 and optionally information about the user and/or client computing device (e.g., information in a corresponding ownership account 123, information supplied in the acquisition request, etc.) to determine whether to authorize the requested acquisition for one or more physical goods from the manufacturer to cause access to those one or more physical goods to be provided to the user as a new recipient of those physical goods. If access is not provided, the TIM system may respond with an error message or other reply denying the access to that client computing device, and otherwise the TIM system grants the access to the user, including to mint and store a new blockchain inventory management control token 175 on the public blockchain storage nodes to establish and represent that granted access, and with corresponding information updated in the new recipient's ownership account 123. In addition, corresponding manufacturing requests and/or instructions are then provided to the corresponding manufacturing facility 185 to cause the corresponding one or more physical goods to be manufactured and then delivered or otherwise provided to the user, with such manufacturing requests and/or instructions being provided in this example embodiment by the TIM system and/or the new recipient user (or the user's computing device 145)—in other embodiments and situations, the manufacturing facility's computing systems may instead generate its own instructions by monitoring the public block chain storage nodes to identify when new inventory management control tokens are issued or otherwise receive notification of such issuance (e.g., using a push notification system). Since the blockchain storage nodes 170 are public, other entities may also access and view information about the blockchain inventory management control tokens 175, including users corresponding to client computing devices 145 and/other third parties on other computing systems 180.

Similarly, in at least some embodiments, the TIM system may support the transfer of a previously acquired physical good from the current recipient to a potential new recipient, such as in accordance with inventory management instructions previously received from the manufacturer of the physical good (e.g., including associated inventory-related criteria 121). In at least some such embodiments, a current recipient of the physical good may initiate an inventory transfer request to the TIM system, which similarly determines whether to authorize the transfer (e.g., in accordance with associated inventory-related criteria and other inventory management instructions from the manufacturer; using information about the current and/or potential new recipients, such as from corresponding ownership accounts and/or based on information received in the transfer request; etc.). If access of the potential new recipient to the physical good for the transfer is not provided, the TIM system may respond with an error message or other reply denying the access to that client computing device, and otherwise the TIM system grants the access to the user, including to modify the inventory management control tokens 175 stored on the public block chain storage nodes to effect the transfer, and with corresponding information updated in the existing (now prior) and new recipients' ownership accounts 123—as discussed in greater detail elsewhere herein, such modifications may include changing ownership information associated with an existing previously issued inventory management control token associated with the physical good being transferred and/or may include issuing one or more new tokens 175 to be stored on the public block chain storage. In other embodiments, such an inventory transfer request may be initiated in other manners, such as by the potential new recipient to the TIM system, by the manufacturer (e.g., to recover ownership of the physical good if corresponding specified conditions are satisfied or are not satisfied by the current recipient).

In this manner, an embodiment of the TIM system may perform automated operations for controlling access to inventory of physical goods produced by a manufacturer based at least in part on inventory management control tokens stored on blockchain storage, as well as according to defined criteria and associated user ownership account information. It will be appreciated that such a TIM system may operate in other environments in other embodiments, including to store and use at least some such information in other manners. In addition, in some embodiments and situations, the TIM system may control access to inventory corresponding to multiple types of physical goods being manufactured by one or more manufacturing facilities operated by one or more manufacturing entities (e.g., manufacturers), whether simultaneously or consecutively. Furthermore, in at least some embodiments, users in an environment such as that of FIG. 1A may instead interact directly with the one or more computing systems 190 executing the TIM system, such as via use of the I/O components 110 and without interacting over the networks 195 and/or without using separate client computing devices 145.

FIG. 1B illustrates an alternative example environment in which an embodiment of a Token Inventory Management (TIM) system is provided and used for controlling access to inventory based at least in part on inventory management control tokens stored on blockchain storage, such as in a manner similar to that of FIG. 1A, but with the physical goods already having been manufactured and available in the illustrated embodiment from one or more physical goods distribution facilities 187 operated by one or more distributing entities (e.g., the manufacturer of the physical goods, a separate distributor of the physical goods, another type of provider of the physical goods, etc.). In this example embodiment, an operator of a distribution facility 187 provides inventory management instructions to the TIM system 160, with corresponding inventory-related criteria and other inventory management instructions being stored as part of information 121 on storage 120 in a manner similar to that discussed with respect to FIG. 1A. The TIM system may similarly receive inventory acquisition and/or transfer request from users 150 of client computing devices 145, with the TIM system similarly determining whether to authorize such access in accordance with information about corresponding recipients (one or both of an existing recipient and a potential new recipient in the case of a transfer) and/or the received inventory management instructions, with granted access including the issuance of corresponding inventory management control tokens 175 stored on the public block chain storage nodes 170 that cause the corresponding distribution facility 187 to distribute the corresponding physical goods 188 to the new recipient, and with corresponding information updated in the new recipient's ownership account 123. The other illustrated components of FIG. 1B may operate in a manner similar to that of FIG. 1A. In addition, in some embodiments and situations, the TIM system may control access to inventory corresponding to multiple types of physical goods provided by one or more distribution facilities operated by one or more distributing entities, whether simultaneously or consecutively. Furthermore, in at least some embodiments, users in an environment such as that of FIG. 1B may instead interact directly with the one or more computing systems 190 executing the TIM system, such as via use of the I/O components 110 and without interacting over the networks 195 and/or without using separate client computing devices 145.

In this manner, an embodiment of the TIM system may perform automated operations for controlling access of users to distributed inventory items based at least in part on inventory management control tokens stored on blockchain storage, as well as according to defined criteria and associated user ownership account information.

In addition, while not illustrated in FIGS. 1A and 1B, in other embodiments the TIM system may similarly control the manufacture and/or distribution of digital items, whether instead of or in addition to physical goods, including in at least some embodiments for the inventory management control tokens to be some or all of those digital items (e.g., to control the manufacture and/or distribution of non-fungible tokens used as the inventory management control tokens), while in other embodiments the digital items may be non-fungible tokens that are separate from their associated inventory management control tokens. It will be appreciated that such a TIM system may operate in other environments in other embodiments, including to store and use at least some such information in other manners.

In some embodiments and situations, the TIM system may further provide an acquisition checkout process that is integrated with other functionality of the TIM system, such as for physical goods and/or digital items, and optionally in accordance with cryptographic wallets used during the checkout process (e.g., cryptographic wallets that are provided by the TIM system, such as in conjunction with user accounts 123; cryptographic wallets that are provided by another system, not shown, and with which the TIM system interacts; etc.). As one non-exclusive example, when a user has requested or otherwise initiated an acquisition of one or more items (e.g., physical goods, digital items, etc.) but before that acquisition process is complete, the TIM system may perform activities that include some or all of the following: determining whether the acquisition request is authorized; obtaining metadata information associated with the item and/or the acquisition, such as after the acquisition is authorized and optionally initiated, including information such as a certificate of authenticity, shipping or other delivery information; warranty information and/or other associated terms related to the acquisition and/or use of the item; updating information available during the checkout process and before it is completed to show or otherwise provide some or all such metadata information (e.g., to show a visual representation of a corresponding inventory management control token generated for the item acquisition); updating information that is in or otherwise associated with the user's cryptographic wallet, during the item acquisition checkout process and/or immediately upon completion of the item acquisition checkout process, such that an acquired non-fungible token or other digital item is available in the cryptographic wallet upon completion of the checkout process (e.g., in a real-time or near-real-time manner with respect to the completion of the checkout process, such as immediately, in less than a second, within seconds, within minutes, etc. and/or such that metadata information for an acquired physical good is similarly available in the cryptographic wallet upon completion of the checkout process; etc. In this manner, the automated operations of the TIM system (e.g., for authenticating and approving an item acquisition) may be integrated within the checkout process for an item acquisition, such as with respect to cryptographic wallets provided by the TIM system and/or by another system. A user may initiate such an acquisition process for an item in various manners, including to identify the item in various manners (e.g., select from a display of multiple available items; scan a QR code or other bar code associated with the item; take a picture of the item; etc.). In addition, such metadata information related to an item acquisition may be stored as part of or otherwise in association with one or more inventory management control tokens issued for the item acquisition, including to store such metadata information on one or more blockchain storage systems as part of or otherwise in association with those one or more inventory management control tokens, as discussed elsewhere herein.

It will be appreciated that the illustrated computing systems and devices in FIGS. 1A and 1B are merely illustrative and are not intended to limit the scope of the present invention. More generally, a “client” or “server” computing system or device may comprise any combination of hardware that can interact and perform the described types of functionality, such as when programmed or otherwise configured with software, including without limitation desktop computers, laptop computers, slate computers, tablet computers, embedded computers, specialized hardware such as ASICs (“application-specific integrated circuits”) or other computers, smart phone computing devices and other cell phones, Internet appliances, PDAs and other electronic organizers, database servers, network storage devices and other network devices, wireless phones, pagers, television-based systems (e.g., using set-top boxes and/or personal/digital video recorders and/or game consoles and/or media servers), and various other consumer products that include appropriate inter-communication capabilities. For example, the illustrated system 160 and/or its components may include executable software instructions and/or data structures in at least some embodiments, which when loaded on and/or executed by particular computing systems or devices may be used to program or otherwise configure those systems or devices, such as to configure hardware processors of those systems or devices. Alternatively, in other embodiments, some or all of the software components and/or systems may execute in memory on another device and communicate with the illustrated computing system/device via inter-computer communication. In addition, while various items are illustrated as being stored in memory or on storage at various times (e.g., while being used), these items or portions of them can be transferred between memory and storage and/or between storage devices (e.g., at different locations) for purposes of memory management and/or data integrity. Furthermore, the functionality provided by the illustrated system components may in some embodiments be combined in fewer components or distributed in additional components. Similarly, in some embodiments the functionality of some of the illustrated components may not be provided and/or other additional functionality may be available.

Thus, in at least some embodiments, the illustrated components and/or systems are software-based components/systems including software instructions that, when executed by the CPU(s) of systems 190 and/or of other systems executing the TIM system 160 and/or other hardware processor means, program the processor(s) to automatically perform the described operations for that component/system, including to use and execute routines and other algorithms as described herein. Furthermore, in some embodiments, some or all of the components and/or systems may be implemented or provided in other manners, such as at least partially in firmware and/or hardware means, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the systems, components or data structures may also be stored (e.g., as software instructions contents or structured data contents) on a non-transitory computer-readable storage medium, such as a hard disk or flash drive or other non-volatile storage device, volatile or non-volatile memory (e.g., RAM), a network storage device, or a portable media article (e.g., a DVD disk, a CD disk, an optical disk, a flash memory device, etc.) to be read by an appropriate drive or via an appropriate connection. The systems, components and data structures may also in some embodiments be transmitted as generated data signals (e.g., as part of a carrier wave or other analog or digital propagated signal) on a variety of computer-readable transmission mediums, including wireless-based and wired/cable-based mediums, and can take a variety of forms (e.g., as part of a single or multiplexed analog signal, or as multiple discrete digital packets or frames). Such computer program products may also take other forms in other embodiments. Accordingly, the present invention may be practiced with other computer system configurations.

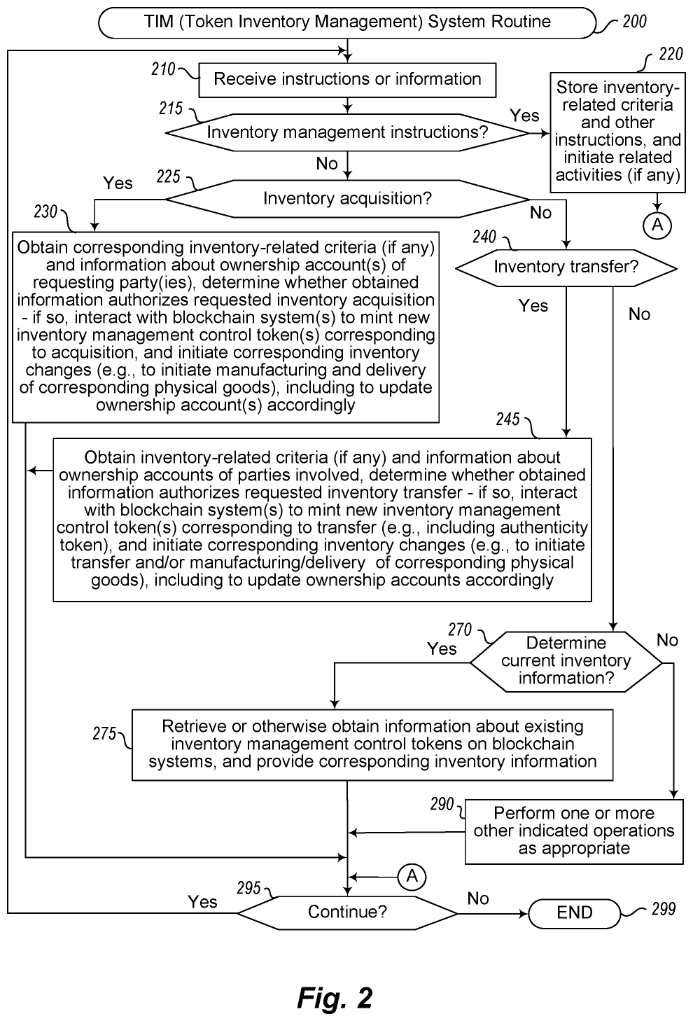

FIG. 2 illustrates a flow diagram of an example embodiment of a Token Inventory Management system routine 200 to perform at least some of the described techniques. The routine may be performed by, for example, execution of the TIM system 160 of FIGS. 1A and/or 1B, and/or to provide functionality of the TIM system as is otherwise described herein. While the illustrated embodiment of the routine indicates serial interactions with one or more users and/or other entities, it will be appreciated that some embodiments may support simultaneous access of numerous users and/or other entities to functionality of the system.

In the illustrated embodiment, the routine begins in block 210, where instructions or information are received, such as from a user or associated client computing device (e.g., from a program executing on such a client device) or from another entity (e.g., a manufacturer, distributor, other item provider, etc.). The routine continues to block 215, where it determines whether the instructions or other information received in block 210 correspond to information about inventory management instructions to be implemented, such as from a manufacturer of physical goods, a distributor of physical goods, a provider of physical goods or other inventory items, etc. If so, the routine continues to block 220, where it stores the inventory management instructions for later use, including any inventory-related criteria, and optionally takes any further activities corresponding to the inventory management instructions—as one non-exclusive example, if a manufacturer or other entity provides inventory management instructions about current or scheduled availability of inventory items of one or more types, the routine may take activities to make information about those inventory items available to possible recipients (whether immediately or at a later time of scheduled availability), such as to publish related information on a website or other information source, to push related information to one or more users or other parties that have requested such information, etc. In some situations, the received instructions may include modifying or removing previously specified inventory management instructions.

If it is instead determined in block 215 that the information received in block 210 is not inventory management instructions, the routine continues instead to block 225, where it determines if the instructions or other information received in block 210 correspond to a request or instruction to acquire one or more inventory items, such as on behalf of one or more potential new recipients (e.g., a request from a potential new recipient to acquire one or more indicated items for the potential new recipient). If so, the routine continues to block 230 where it obtains inventory-related criteria (if any) for the item(s) and information about the potential new recipient(s), such as by retrieving corresponding stored information (e.g., at least in part from an ownership account of the potential new recipient, from previously supplied inventory management instructions related to the item(s), etc.) and/or obtaining the information in block 210, and uses the obtained information to determine whether to authorize new access for the potential new recipient(s) to the item(s) corresponding to the request or other instructions. If such access is determined to not be authorized, the routine may reply with an error message or other indication of denial of the access request (not shown in the flow diagram), or instead may in some situations and embodiments take no action (e.g., if access is denied unless explicitly granted). If such access is determined to be authorized, the routine further interacts with a blockchain system to mint one or more corresponding new inventory management control tokens on it that establish and represent the new access, and then initiates the corresponding access, such as by providing corresponding instructions to a manufacturer to manufacture and provide the item(s) to the new recipient(s), by providing corresponding instructions to a provider to provide the item(s) to the new recipient(s), by allowing the manufacturer or other provider to review the new issued token(s) and take corresponding activities in response to the issuance, etc. In addition, the routine may further update the ownership account(s) of the recipient(s) accordingly, such as to reflect the authorization or denial of the access event and any corresponding item ownership changes, and to update stored information for the manufacturer or other provider to reflect that the allocated items are no longer available (e.g., if there is a limit on the quantity of items that may be acquired), as well as take other actions (if any) specified in the inventory management instructions for the item(s).

If it is instead determined in block 225 that the information received in block 210 does not correspond to a request or instruction to acquire one or more inventory items, the routine continues instead to block 240, where it determines if the instructions or other information received in block 210 correspond to a request or instruction to transfer one or more inventory items from one or more current recipients that own the item(s) to one or more potential new recipients (e.g., a request from a current recipient/owner to transfer one or more indicated items to a potential new recipient, a request from a potential new recipient to acquire one or more indicated items from a current recipient/owner, etc.). If so, the routine continues to block 245 where it obtains inventory-related criteria (if any) for the item(s) and information about the current and potential new recipient(s), such as by retrieving corresponding stored information (e.g., at least in part from an ownership account of the recipients, from previously supplied inventory management instructions related to the item(s), etc.) and/or obtaining the information in block 210, and uses the obtained information to determine whether to authorize new access for the transfer of the item(s) to the potential new recipient(s) corresponding to the request or other instructions. If such access is determined to not be authorized, the routine may reply with an error message or other indication of denial of the access request (not shown in the flow diagram), or instead may in some situations and embodiments take no action (e.g., if access is denied unless explicitly granted). If such access is determined to be authorized, the routine further interacts with a blockchain system to establish one or more corresponding inventory management control tokens that represent the new access, and then initiates the corresponding access, such as by providing corresponding instructions to the current recipient(s) to provide the item(s) to the new recipient(s), by providing corresponding instructions to a manufacturer or other provider to provide a new copy of each of the item(s) to the new recipient(s), etc.—as discussed in greater detail elsewhere herein, the establishing of the inventory management control token(s) for the transfer may include one or more of transferring ownership to a new recipient of one or more existing inventory management control tokens associated with the one or more items that are being transferred, minting one or more new inventory management control tokens corresponding to ownership by the new recipient(s), minting one or more authenticity inventory management control tokens that confirm that the item(s) being transferred are authentic and/or valid, etc. In addition, the routine may further update the ownership account(s) of the recipient(s) accordingly, such as to reflect the authorization or denial of the access event and any corresponding item ownership changes, and optionally to update stored inventory management instructions information for the manufacturer or other provider to reflect the transfer, as well as take other actions (if any) specified in the inventory management instructions for the item(s) (e.g., to provide a portion of an acquisition price to the manufacturer and/or other provider of the item(s), to revert ownership of the item(s) to the manufacturer and/or other provider of the item(s) if transfer-related criteria are not satisfied, etc.).

If it is instead determined in block 240 that the instructions or other information received in block 210 are not a request or other instructions for transfer of one or more items, the routine continues instead to block 270, where it determines whether the instructions or other information received in block 210 are to determine current inventory-related information related to one or more indicated items and/or recipients (e.g., to verify current ownership of a particular item, to determine what items are owned by a particular recipient user, to determine what recipient users own one or more indicated items or item types, etc.). If so, the routine continues to block 275, where the routine retrieves or otherwise obtains corresponding information (e.g., information about existing inventory management control tokens on the blockchain system(s) that represent current access), and provides corresponding response information.

If it is instead determined in block 270 that the instructions or other information received in block 210 are not to determine current inventory-related information, the routine continues instead to block 290, where it optionally performs one or more other indicated operations as appropriate. Non-exclusive examples of some such other operations include obtaining and storing information about users, creating ownership accounts for new users (e.g., including to optionally specify an initial balance and/or maximum balance of resource access replenishment credits for that user, such as in response to corresponding information and/or instructions provided by that user), obtaining and storing information about one or more inventory items to which access is to be managed, obtaining and storing information about one or more manufacturers or other providers of inventory items whose access is to be managed, receiving and responding to other types of requests for information, etc.

After blocks 220, 230, 245, 275 or 290, the routine continues to block 295 to determine whether to continue, such as until an explicit indication to terminate is received, or instead to continue only if an explicit indication to continue is received. If it is determined to continue, the routine returns to block 210, and otherwise continues to block 299 and ends.

Non-exclusive example embodiments described herein are further described in the following clauses.

A01. A computer-implemented method comprising:

receiving, by one or more computing systems, information about access of a user to one or more inventory items;

determining, by the one or more computing systems, to authorize the access of the user to the one or more inventory items according to one or more defined inventory-related criteria; and

providing, by the one or more computing systems, an indication of authorization of the access, including generating, in response to the determining, one or more new tokens on a publicly accessible blockchain system to represent the authorization of the access, to cause providing of the one or more inventory items to the user.

A02. The computer-implemented method of clause A01 wherein the one or more inventory items are one or more physical goods of one or more types, wherein the inventory-related criteria are defined by a manufacturer of the one or more physical goods and are provided to a Token Inventory Management system that operates the one or more computing systems, and wherein the providing of the indication of the authorization of the access includes initiating the manufacturer to manufacture the one or more physical goods and to provide the manufactured one or more physical goods to the user.

A03. The computer-implemented method of clause A01 wherein the one or more inventory items are one or more physical goods of one or more types that have been manufactured, wherein the inventory-related criteria are defined by a provider of the one or more manufactured physical goods and are provided to a Token Inventory Management system that operates the one or more computing systems, and wherein the providing of the indication of the authorization of the access includes initiating the provider to provide the one or more manufactured physical goods to the user.

A04. The computer-implemented method of clause A01 wherein the one or more inventory items are one or more non-physical items of one or more types, wherein the inventory-related criteria are defined by a manufacturer of the one or more inventory items and are provided to a Token Inventory Management system that operates the one or more computing systems, and wherein the providing of the indication of the authorization of the access includes initiating the manufacturer to manufacture the one or more inventory items and to provide the manufactured one or more inventory items to the user.

A05. The computer-implemented method of clause A01 wherein the one or more inventory items are one or more non-physical items of one or more types that have been manufactured, wherein the inventory-related criteria are defined by a provider of the one or more manufactured non-physical items and are provided to a Token Inventory Management system that operates the one or more computing systems, and wherein the providing of the indication of the authorization of the access includes initiating the provider to provide the one or more manufactured non-physical items to the user.

A06. A computer-implemented method comprising:

receiving, by one or more computing systems, an indication of a checkout process initiated for an acquisition by a user of one or more inventory items;

determining, by the one or more computing systems and during the checkout process, to authorize the access of the user to the one or more inventory items according to one or more defined inventory-related criteria; and

providing, by the one or more computing systems and before the checkout process is completed, an indication of authorization of the access, including generating, in response to the determining, one or more new tokens on a publicly accessible blockchain system.

A07. The computer-implemented method of any one of clauses A01-A06 wherein the user is associated with a software program executing on a client device, and wherein the method further comprises accessing, by the user and after the providing of the indication of the authorization of the access, the one or more inventory items.

A08. The computer-implemented method of any one of clauses A01-A07 further comprising accessing, by the user and after the providing of the indication of the authorization of the access, functionality associated with the one or more inventory items.

A09. The computer-implemented method of any one of clauses A01-A08 wherein the receiving of the information about access of the user to the one or more inventory items includes receiving an acquisition request for the one or more inventory items on behalf of the user, and wherein the determining to authorize the access of the user to the one or more inventory items according to one or more defined inventory-related criteria includes determining, by the one or more computing systems, that information associated with the acquisition request satisfies the one or more defined inventory-related criteria.

A10. The computer-implemented method of any one of clauses A01-A09 wherein the receiving of the information about access of the user to the one or more inventory items includes receiving an acquisition request from the user for the one or more inventory items, and wherein the determining to authorize the access of the user to the one or more inventory items according to one or more defined inventory-related criteria includes determining, by the one or more computing systems, that an ownership account associated with the user includes information usable to obtain the access.

A11. The computer-implemented method of clause A10 further comprising using, by the one or more computing systems and as part of the determining to authorize the access of the user to the one or more inventory items according to one or more defined inventory-related criteria, information in the ownership account associated with the user to satisfy acquisition pricing associated with the access of the user to the one or more inventory items.

A12. The computer-implemented method of any one of clauses A01-A11 wherein the one or more computing systems provide a Token Inventory Management system that performs the determining to authorize the access of the user to the one or more inventory items according to one or more defined inventory-related criteria, and wherein the one or more new tokens are each an inventory management control token issued by the Token Inventory Management system.

A13. The computer-implemented method of any one of clauses A01-A12 wherein the one or more new tokens are non-fungible tokens, and wherein the one or more inventory items are the non-fungible tokens.

A14. The computer-implemented method of any one of clauses A01-A13 wherein the receiving of the information about access of the user to the one or more inventory items is part of a checkout process for an acquisition by the user of the one or more inventory items, and wherein the determining to authorize the access of the user to the one or more inventory items according to one or more defined inventory-related criteria occurs as part of the acquisition checkout process and includes providing information to the user about at least one of whether the acquisition is authorized or about how the acquisition will occur.

A15. The computer-implemented method of clause A14 wherein the acquisition checkout process involves use of a cryptographic wallet by the user, and wherein the method further comprises, during the acquisition checkout process, acquiring, by the one or more computing systems, metadata information associated with at least one of the one or more inventory items or the acquisition of the one or more inventory items, and displaying, by the one or more computing systems, the acquired metadata information to the user before completion of the acquisition checkout process.

A16. The computer-implemented method of any one of clauses A14-A15 wherein the acquired metadata information includes information about at least one of a certificate of authenticity for at least one of the one or more inventory items, or delivery information about delivery to the user of at least one of the one or more inventory items, or one or more terms associated with the acquisition of at least one of the one or more inventory items and/or with use of at least one of the one or more inventory items.

A17. The computer-implemented method of any one of clauses A14-A16 wherein the acquisition checkout process involves use of a cryptographic wallet by the user, and wherein the method further comprises, upon completion of the acquisition checkout process, providing, by the one or more computing systems, access via the cryptographic wallet to at least one of the one or more inventory items, and/or to metadata information associated with at least one of the one or more inventory items or the acquisition of the one or more inventory items.

A18. The computer-implemented method of clause A17 wherein the providing of the access occurs in at least one of a real-time manner upon the completion of the acquisition checkout process or a near-real-time manner upon the completion of the acquisition checkout process, wherein the at least one of the one or more inventory items is a digital item, and wherein the providing of the access via the cryptographic wallet includes adding the digital item to the cryptographic wallet.

A19. The computer-implemented method of any one of clauses A17-A18 wherein the providing of the access occurs in at least one of a real-time manner upon the completion of the acquisition checkout process or a near-real-time manner upon the completion of the acquisition checkout process, wherein the one or more inventory items include at least one physical good, wherein the providing of the access via the cryptographic wallet includes adding the metadata information to the cryptographic wallet, and wherein the acquired metadata information includes information about at least one of a certificate of authenticity for the at least one physical good, or delivery information about delivery to the user of the at least one physical good, or one or more terms associated with the acquisition of the at least one physical good and/or with use of the at least one physical good.

A20. The computer-implemented method of any one of clauses A01-A19 wherein the user is associated with a software program executing on a client device, and wherein the method further comprises accessing, by the client device and after the providing of the indication of the authorization of the access, the one or more inventory items.

A21. The computer-implemented method of any one of clauses A01-A20 further comprising initiating, by the one or more computing systems and in response to the authorization of the access, providing of the one or more inventory items to the user.

A22. A computer-implemented method comprising multiple steps to perform automated operations that implement described techniques substantially as disclosed herein.

B01. A non-transitory computer-readable medium having stored executable software instructions and/or other stored contents that cause one or more computing systems to perform automated operations that implement the method of any of clauses A01-A22.

B02. A non-transitory computer-readable medium having stored executable software instructions and/or other stored contents that cause one or more computing systems to perform automated operations that implement described techniques substantially as disclosed herein.

C01. One or more computing systems comprising one or more hardware processors and one or more memories with stored instructions that, when executed by at least one of the one or more hardware processors, cause the one or more computing systems to perform automated operations that implement the method of any of clauses A01-A22.

C02. One or more computing systems comprising one or more hardware processors and one or more memories with stored instructions that, when executed by at least one of the one or more hardware processors, cause the one or more computing systems to perform automated operations that implement described techniques substantially as disclosed herein.

D01. A computer program adapted to perform the method of any of clauses A01-A22 when the computer program is run on a computer.

Aspects of the present disclosure are described herein with reference to flowchart illustrations and/or block diagrams of methods, apparatus (systems/devices), and computer program products according to embodiments of the present disclosure. It will be appreciated that each block the flowchart illustrations and/or block diagrams, and combinations of such blocks, can be implemented by computer-readable program instructions. It will be further appreciated that in some implementations the functionality provided by the routines discussed above may be provided in alternative ways, such as being split among more routines or consolidated into fewer routines. Similarly, in some implementations illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel, or synchronous or asynchronous) and/or in a particular order, in other implementations the operations may be performed in other orders and in other manners. Any data structures discussed above may also be structured in different manners, such as by having a single data structure split into multiple data structures and/or by having multiple data structures consolidated into a single data structure. Similarly, in some implementations illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by corresponding claims and the elements recited by those claims. In addition, while certain aspects of the invention may be presented in certain claim forms at certain times, the inventors contemplate the various aspects of the invention in any available claim form. For example, while only some aspects of the invention may be recited as being embodied in a computer-readable medium at particular times, other aspects may likewise be so embodied.

What is claimed is:

1. A computer-implemented method comprising:
receiving, by one or more computing systems, information about access of a user to one or more inventory items;
determining, by the one or more computing systems, to authorize the access of the user to the one or more inventory items according to one or more defined inventory-related criteria; and
providing, by the one or more computing systems, an indication of authorization of the access, including generating, in response to the determining, one or more new tokens on a publicly accessible blockchain system to represent the authorization of the access, to cause providing of the one or more inventory items to the user.

2. The computer-implemented method of claim 1 wherein the one or more inventory items comprise one or more physical goods of one or more types, wherein the inventory-related criteria are defined by a manufacturer of the one or more physical goods and are provided to a Token Inventory Management system that operates the one or more computing systems, and wherein the providing of the indication of the authorization of the access includes initiating the manufacturer to manufacture the one or more physical goods and to provide the one or more physical goods to the user.

3. The computer-implemented method of claim 1 wherein the one or more inventory items are one or more physical goods of one or more types that have been manufactured, wherein the inventory-related criteria are defined by a provider of the one or more physical goods and are provided to a Token Inventory Management system that operates the one or more computing systems, and wherein the providing of the indication of the authorization of the access includes initiating the provider to provide the one or more physical goods to the user.

4. The computer-implemented method of claim 1 wherein the one or more inventory items are one or more non-physical items of one or more types, wherein the inventory-related criteria are defined by a manufacturer of the one or more inventory items and are provided to a Token Inventory Management system that operates the one or more computing systems, and wherein the providing of the indication of the authorization of the access includes initiating the manufacturer to manufacture the one or more inventory items and to provide the one or more inventory items to the user.

5. The computer-implemented method of claim 1 wherein the one or more inventory items are one or more non-physical items of one or more types that have been manufactured, wherein the inventory-related criteria are defined by a provider of the one or more non-physical items and are provided to a Token Inventory Management system that operates the one or more computing systems, and wherein the providing of the indication of the authorization of the access includes initiating the provider to provide the one or more non-physical items to the user.

6. A computer-implemented method comprising:
receiving, by one or more computing systems, an indication of a checkout process initiated for an acquisition by a user of one or more inventory items;
determining, by the one or more computing systems and during the checkout process, to authorize access of the user to the one or more inventory items according to one or more defined inventory-related criteria; and
providing, by the one or more computing systems and before the checkout process is completed, an indication of authorization of the access, including generating, in response to the determining, one or more new tokens on a publicly accessible blockchain system.

7. The computer-implemented method of any one of claim 6 wherein the user is associated with a software program executing on a client device, and wherein the method further comprises accessing, by the user and after the providing of the indication of the authorization of the access, the one or more inventory items.

8. The computer-implemented method of any one of claim 7 further comprising accessing, by the user and after the providing of the indication of the authorization of the access, functionality associated with the one or more inventory items.

9. The computer-implemented method of any one of claim 8 wherein the receiving of information about access of the user to the one or more inventory items includes receiving an acquisition request for the one or more inventory items on behalf of the user, and wherein the determining to authorize the access of the user to the one or more inventory items according to one or more defined inventory-related criteria includes determining, by the one or more computing systems, that information associated with the acquisition request satisfies the one or more defined inventory-related criteria.

10. The computer-implemented method of any one of claim 9 wherein the receiving of the information about access of the user to the one or more inventory items includes receiving an acquisition request from the user for the one or more inventory items, and wherein the determining to authorize the access of the user to the one or more inventory items according to one or more defined inventory-related criteria includes determining, by the one or more computing systems, that an ownership account associated with the user includes information usable to obtain the access.

11. The computer-implemented method of claim 10 further comprising using, by the one or more computing systems and as part of the determining to authorize the access of the user to the one or more inventory items according to one or more defined inventory-related criteria, information in the ownership account associated with the user to satisfy acquisition pricing associated with the access of the user to the one or more inventory items.

12. The computer-implemented method of any one of claim 11 wherein the one or more computing systems provide a Token Inventory Management system that performs the determining to authorize the access of the user to the one or more inventory items according to one or more defined inventory-related criteria, and wherein the one or more new tokens are each an inventory management control token issued by the Token Inventory Management system.

13. The computer-implemented method of any one of claim 12 wherein the one or more new tokens are non-fungible tokens, and wherein the one or more inventory items are the non-fungible tokens.

14. The computer-implemented method of any one of claim 13 wherein the receiving of the information about access of the user to the one or more inventory items is part of a checkout process for an acquisition by the user of the one or more inventory items, and wherein the determining to authorize the access of the user to the one or more inventory items according to one or more defined inventory-related criteria occurs as part of the acquisition checkout process and includes providing information to the user about at least one of whether the acquisition is authorized or about how the acquisition will occur.

15. The computer-implemented method of claim 14 wherein the acquisition checkout process involves use of a cryptographic wallet by the user, and wherein the method further comprises, during the acquisition checkout process, acquiring, by the one or more computing systems, metadata information associated with at least one of the one or more inventory items or the acquisition of the one or more inventory items, and displaying, by the one or more computing systems, the acquired metadata information to the user before completion of the acquisition checkout process.

16. The computer-implemented method of any one of claim 15 wherein the acquired metadata information includes information about at least one of a certificate of authenticity for at least one of the one or more inventory items, or delivery information about delivery to the user of at least one of the one or more inventory items, or one or more terms associated with the acquisition of at least one of the one or more inventory items and/or with use of at least one of the one or more inventory items.

17. The computer-implemented method of any one of claim 16 wherein the acquisition checkout process involves use of a cryptographic wallet by the user, and wherein the method further comprises, upon completion of the acquisition checkout process, providing, by the one or more computing systems, access via the cryptographic wallet to at least one of the one or more inventory items, and/or to metadata information associated with at least one of the one or more inventory items or the acquisition of the one or more inventory items.

18. The computer-implemented method of claim 17 wherein the providing of the access occurs in at least one of a real-time manner upon the completion of the acquisition checkout process or a near-real-time manner upon the completion of the acquisition checkout process, wherein the at least one of the one or more inventory items is a digital item, and wherein the providing of the access via the cryptographic wallet includes adding the digital item to the cryptographic wallet.

19. The computer-implemented method of any one of claim 18 wherein the providing of the access occurs in at least one of a real-time manner upon the completion of the acquisition checkout process or a near-real-time manner upon the completion of the acquisition checkout process, wherein the one or more inventory items include at least one physical good, wherein the providing of the access via the cryptographic wallet includes adding the acquired metadata information to the cryptographic wallet, and wherein the acquired metadata information includes information about at least one of a certificate of authenticity for the at least one physical good, or delivery information about delivery to the user of the at least one physical good, or one or more terms associated with the acquisition of the at least one physical good and/or with use of the at least one physical good.

20. The computer-implemented method of any one of claim 19 wherein the user is associated with a software program executing on a client device, and wherein the method further comprises accessing, by the client device and after the providing of the indication of the authorization of the access, the one or more inventory items.

21. The computer-implemented method of any one of claim 20 further comprising initiating, by the one or more computing systems and in response to the authorization of the access, providing of the one or more inventory items to the user.
